(19) United States
(12) Patent Application Publication
(10) Pub. No.: US 2016/0179060 A1
(43) Pub. Date: Jun. 23, 2016

(54) Anyiams Voice Thermoa Watch

(71) Applicant: Thony Chukwuemezie Anyiam, Bladensburg, MD (US)

(72) Inventor: Thony Chukwuemezie Anyiam, Bladensburg, MD (US)

(21) Appl. No.: 14/577,360

(22) Filed: Dec. 19, 2014

(51) Int. Cl. G04G 9/00; G08B 3/00; G04G 21/02

(52) U.S. Cl. CPC G04G 9/0064; G04G 21/02; G08B 3/00

(57) ABSTRACT

Anyiams Voice Thermoa Smart Watch displays and announces in voice current indoor, and outdoor temperature, location and current time. Audio announcement in major languages around the world, including Swahili.

A special alarm feature will alert wearer when set temperature falls below a set degree (cold) or rises above a set degree (hot)

Watch can be worn on the wrist, around the neck as a pendant or in the pocket as a pocket watch.

The many features make watch useful to those that are visually and hearing impaired, parents, hikers, traveler, watch collectors, and general population.

Anyiams Thermoa voice watch with temperature, time, and date announces current indoor or outdoor temperature in voice and digital display wherever and whenever the talk button is pressed, and on the hour.

Anyiams Thermoa Smart watch is a welcome addition for the visual and hearing impaired, parents, and the general population.

The current indoor temperature is close to you as on your wrist, pocket or purse. No need to turn on your phone, computer, radio or television to check the current indoor temperature. No longer have to guess when to turn on or off the heater or air conditioner.

Even in the dark, you have a choice of audio or voice announcement of the current indoor temperature or display in clear, bold digital letters the current temperature, and time with a press of the talk or light illumination button.

One of the many features includes; first ever voice dual time and temperature alarm feature.

First ever voice indoor and outdoor temperature, time and date watch. A special alarm feature will alert the wearer when set temperature falls below a set degree (cold) or rises above a set degree (hot)

Anyiams Thermoa voice watch with temperature, time, and the day will announce the current temperature (indoor and outdoor) and time on the hour, or whenever the talk button/crown T003 or backlight button T008 is pressed.

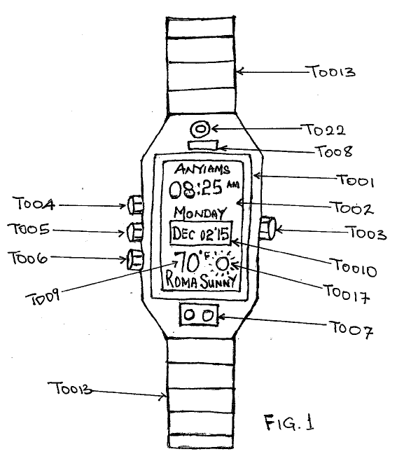

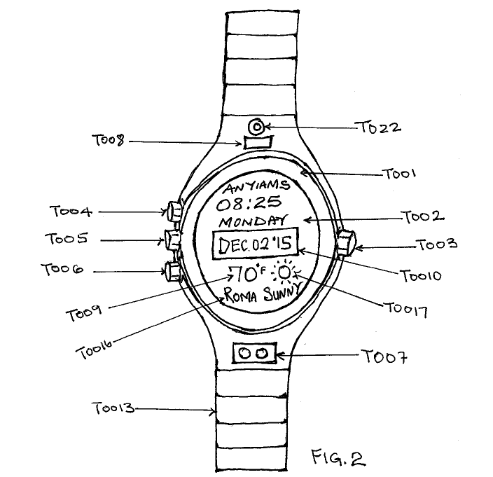

Anyiams Voice Thermoa smart watch comes in a male version FIG. 1 and a female version FIG. 2. Both watches have similar features and functions.

Male watch is rectangular in shape, while the female version is roundish or oval in shape. Female version comes in different soft colors depending on individual preference.

The watch has a special alarm feature when set will alert the wearer when set temperature falls below a set degree (cold) or rises above a set degree (hot) The alarm will continue until it is turned off or temperature retreats from set the temperature.

Current temperature is announced in the major language of the wearer choice, including, but not limited to, English, Spanish, French, Mandarin, Portuguese, Arabic, Italian, Japanese, and Swahili.

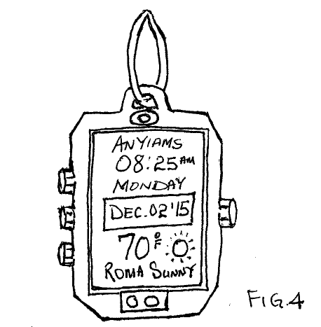

Said watch can be worn as a pocket watch, and as a pendant watch FIG. 4 Said wrist watches comprises of a wrist band T0013 that goes round the wrist, with lugs that support the band.

A case T001 houses the crystal display panel T002 which displays the current temperature, time, day, location, date and year.

There are five pusher/buttons in all, 3 control buttons on the left: Mode set button T004, Set button T005, Volume control T006. The talk button/Crown T003 is strategically placed or isolated on the right side for easy access in the dark and for visually impaired individuals.

The back light button T008 when pressed will illuminates the LCD to view information. You can also access current temperature and time with the press of the backlight button any time

A mini window T0010 houses the calendar display of the current month, day, and year. Said watch has a five level volume control T006 and audio speakers T007. To access current temperature; when talk button or crown T003 is pressed, backlight illuminates and a brief chime melody plays for seconds, follows with a voice and a display of the current temperature and time.

The bright sky blue LCD light makes it easy to view the LCD screen display at night and during daytime.

The current temperature reading is generated by the temperature sensor T022. It senses and measures the barometric pressure, temperature, humidity and lightness of the immediate surroundings. The temperature sensor is isolated from the watch case T001, that way it will immediately react to changes in temperature.

For those that are visually impaired, the conveniences of hearing in a clear voice anytime the current indoor or outdoor temperature with the press of a button or on the hour.

Said watch has a voice activated setting option for the visual impaired, functions like setting the alarm and etc. The current temperature is generated with the use of DSP T024 (digital signal processors) sensor which processes and convert analog signals to digital signals. The digital signal is processed in real time via the ASICS (applicable specific integrated circuit) application circuit.

The Thermoa watch in some situations needs minutes to acclimate or adjust to the immediate surroundings temperature when the wearer moves from point A to point B.

Said watch can be alternate between Fahrenheit and Celsius, and is water resistant, and has world timer among other features.

Said watch has 5 grades of volume controls. This feature allows the individual to control, and adjust the volume based on the wearer's desire with the press of the button T006

In normal time mode, pressing the T003, the watch will announce the current temperature, a second press watch will announce the time, and day. A press and hold of the T003 key for 5 seconds watch will announce the current temperature, time and day.

To access current temperature at any time press button/crown T003 or back light T008 once.

In normal time mode, press button T004 to switch between 12 and 24 hour format. Press and hold T005 for 3 seconds to change temperature unit between Centigrade (*C) and Fahrenheit (*F)

For normal audio or voice activated setting, press and hold T004 for 5 second to activate audio setting and follow instruction.

In normal time mode, for normal voice activated setting, press T004 to enter time setting mode T005 with “Hour” and “Minute”, “Month”, “day” and “Year” and follow instructions. Setting mode will exit automatically, and return to previous setting if no key is pressed or idle while in setting mode for 10 seconds.

To set the temperature alarm, in normal time mode, press T004 button twice to enter the alarm time setting mode T005 with hour, minutes, and temp flashing. Press button T004 and follow instruction to set the hour, minute and the temperature degree you wish.

The alarm will be flashing indicating activated when completed. Setting mode will automatically exit, and return to the current display mode after 10 seconds of none activity.

### BRIEF DESCRIPTION OF DRAWINGS

The following drawings illustrate my invention/improvement. Anyiams voice Thermoa voice watch comes in both male and female versions, both have similar functions and features.

Referring to FIG. 1 drawing: Drawing is front view of male version of watch. Rectangular in shape with case T001 houses liquid crystal T002 display of the current temperature T009, time, day, and date.

Referring to FIG. 1 and FIG. 2: T003 is the Crow/Talk button when pressed provide current temperature and time.

Referring to FIG. 1 and FIG. 2: T004 is the Mode button, press to set time and alarm.

Referring to FIG. 1 and FIG. 2: T005—is the Set/Adjustment button press to set/adjust watch.

Referring to FIG. 1 and FIG. 2: T006—is the Volume control button. Continue pressing to adjust the 5 levels volume control.

Referring to FIG. 1 and FIG. 2: T007 is the speaker.

Referring to FIG. 1 and FIG. 2: T008 is the backlight button when pressed illuminates the crystal display panel T002 and also announces current temperature and time.

### BRIEF DESCRIPTION OF DRAWINGS

Referring to FIG. 1 and FIG. 2: T009 is the current temperature digital display.

Referring to FIG. 1 and FIG. 2: T0010 is Mini Window display that shows the current date (Month, Day and Year)

Referring to FIG. 1 and FIG. 2 drawings T0013 is Wrist watch band.

Referring to FIG. 1 and FIG. 2 T0016 location display (City or town)

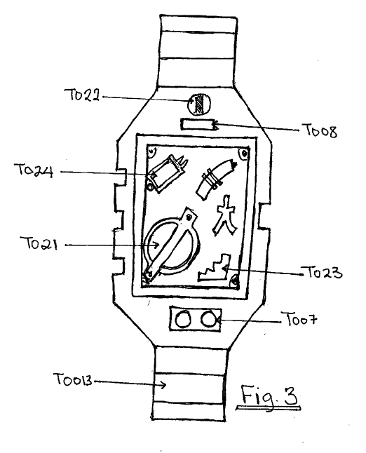

Referring to FIG. 3 drawing T021 is the battery.

Referring to FIG. 3 drawing; T022 Temperature sensor

Referring to FIG. 3 drawing T023 is Water resistance sensor

Referring to FIG. 3 drawing T0024 is the DSP processing sensor

Referring to FIG. 4 drawing shows said watch as a pocket watch.

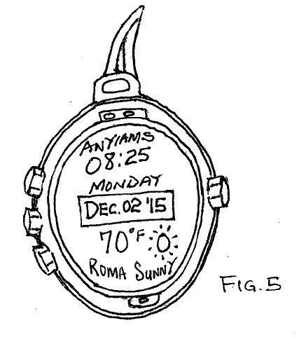

Referring to FIG. 5 drawing shows said watch as a pendant time piece.

### LIST OF DRAWINGS

FIG. 1: Front view of Men's Version.

FIG. 2: Front view of Female version.

FIG. 3: Inside view watch

FIG. 4: Watch as a Pocket watch

FIG. 5: Watch as a Pendant time piece.

What is claimed is:

1. Anyiams Voice Thermoa temperature and time Smart watch comprising; a case, crystal display, a mini display window, multiple alarms features, electronics and mechanical components, expandable and adjustable wrist band.

2. Anyiams voice Thermoa Smart watch of claim 1 wherein further claim said watch announces in voice and digital display current indoor and outdoor temperature, and location.

3. Anyiams voice Thermoa Smart watch of claim 1 wherein further claim watch can be set to warn or alarm wearer when set temperature falls below set degree (cold) or raises above set degree (hot)

4. Anyiams voice Thermoa Smart watch of claim 1 wherein further displays current time, day, month, year, temperature, and weather condition.

5. Anyiams voice Thermoa Smart watch of claim 1, wherein further claim said watch announces in voice current temperature in major languages of wears choice in French, Spanish, Mandarin, Portuguese, and Swahili.

6. Anyiams voice Thermoa Smart watch of claim 1, wherein further claim said watch can be worn on the wrist as a wrist watch, pocket watch, and as a pendant watch.
